(19) United States
(12) Patent Application Publication
(10) Pub. No.: US 2010/0062737 A1
(43) Pub. Date: Mar. 11, 2010

(54) METHOD AND APPARATUS FOR ANTENNA DIVERSITY RECEIVER BASED ON ATSC TECHNOLOGY

(75) Inventors: YAN ZHONG, SAN JOSE, CA (US); LIN YANG, FREMONT, CA (US)

Correspondence Address: FRANK F. TIAN, 331-4A THIRD AVENUE, LONG BEACH, NJ, 07740, US

(73) Assignee: LEGEND SILICON, FREMONT, CA (US)

(21) Appl. No.: 12/207,881

(22) Filed: Sep. 10, 2008

(51) Int. Cl. H04B 1/18

(52) U.S. Cl. 455/277.1

(57) ABSTRACT

A receiver comprises a plurality of paths for receiving wireless signals, each path having a designated antenna; and an antenna diversity chain adapted for information communication between the plurality of paths for a selecting and using a path among the plurality of paths.

### CROSS-REFERENCE TO OTHER APPLICATIONS

The following applications of common assignee and filed on the same day herewith are related to the present application, and are herein incorporated by reference in their entireties:

U.S. patent application Ser. No. 12/041,514 with attorney docket number LSFFT-097.

### FIELD OF THE INVENTION

The present invention relates generally to VSB receivers, more specifically the present invention relates to a novel multi-antenna VSB receiver.

A receiver comprises a plurality of paths for receiving wireless signals, each path having a designated antenna; and an antenna diversity chain adapted for information communication between the plurality of paths for a selecting and using a path among the plurality of paths.

### BACKGROUND

VSB receivers such as fixed location digital terrestrial televisions are known. An IEEE paper entitled “AN FPGA PROTOTYPE OF A FORWARD ERROR CORRECTION (FEC) DECODER FOR ATSC DIGITAL TV” to Haiyun Yang, et al describes a fixed point decoder for an ATSC TV. The afore mentioned paper is hereby incorporated herein by reference. For mobile VSB receivers, signal qualities typically suffer lose of quality due to such factors as multi-path effect, etc.

Digital broadcast nowadays include terrestrial broadcast televisions, which further includes VSB receivers such as ATSC receivers and the like. Because of multi-path effect, diversity system having different reception antennae may be required. To achieve quality reception similar to reception achieved in a stationary home or work environment, diversity reception antennae may be employed in mobile broadcast reception systems. Diversity reception generally implies spatial diversity. Another method that may be used is cross-polarization diversity, which may address problems associated with restricted space in the mobile broadcast reception systems.

As can be seen, a disadvantage with current diversity as employed in mobile reception systems is time varying multi-path fading. Different multi-path intensity profiles exist for a mobile reception system. Multi-path fading may arise in wireless broadcast as a result of reflections from stationary and non-stationary objects.

Multi-path fading is manifested as a random amplitude and phase modulation. At a receiver side, multiple copies of a signal are summed together in either a constructive, or a destructive manner. The destructive addition of the signals may create fading dips in the signal power. The exact phase relationship, including the degree of cancellation, may vary from position to position, thereby making it possible for an antenna at a first location to experience severe destructive cancellation and an antenna at a second location to experience constructive addition.

Diversity techniques aim to improve reception performance by allowing more than one antenna to be used with a common receiver. These antennae may be spatially separated by an appropriate distance or have different polarizations. Thus, selecting the best antenna on a dynamic basis provides some operational advantage such as automatically and dynamically recovering the highest possible signal quality.

Thus, a typical multi-path fading environment may include a signal transmitted from a transmitter received by a receiver mounted in, for example, a vehicle or a hand-held mobile station. In this situation, the signal transmitted may be received directly by the receiver, as well as after having been reflected off various objects in the surrounding environment such as buildings and/or trees. These different signals received are not correlated. However, for many scattering environments, spatial diversity is an effective way to improve the performance of wireless radio systems. The signals (at least two) should be received by the diversity antennae and then switched between or combined in the receiver.

For a mobile DTV receiver, to achieve a reliable reception, a few functions block, such as signal tracking, channel estimation, equalizer and FEC decoder must be carefully designed. But no matter how these functional block are well designed, there are always some cases where the reception is not reliable. Other ways to improve upon the reception includes the use of multiple antennae, which is usually referred as a diversity system.

In a diversity system, there are always two or more antennae with each antenna associated with an input path, the input signal to each path is processed independently at first, and then at a predetermined location down stream the two or more processed signals are combined as a single one information stream and sent to the next source decoder, such as MPEG-2 decoder. There are typically some issues or questions to be answered in this process. For example, at which point, the two or more than two independent signals will be combined? In addition, in order to achieve the most reliable reception, how these two or more than two signals are combined? Therefore, a solution of the diversity system based on a VSB receiver such as a ATSC TV receiver for at least two antennae is provided to solve these two issues or questions of signal quality.

### SUMMARY OF THE INVENTION

In a vestigial sideband (VSB) system, a receiver having at least two antennae is provided to solve the problem of when, where, or how the receiver is to combine the received signals.

A receiver comprises a plurality of paths for receiving wireless signals, each path having a designated antenna; and an antenna diversity chain adapted for information communication between the plurality of paths for a selecting and using at least one path among the plurality of paths.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is an example VSB receiver in accordance with some embodiments of the invention.

FIG. 2 is an example of a prior art VSB receiver.

FIG. 3 is an example of a first aspect of a VSB receiver in accordance with some embodiments of the invention.

FIG. 4 is an example of a second aspect of the VSB receiver in accordance with some embodiments of the invention.

FIG. 5 is an example of a flowchart in accordance with some embodiments of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to a receiver having at least two antennae is provided to solve the problem of when, where, or how the receiver is to combine the received signals. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

It will be appreciated that embodiments of the invention described herein may be comprised of one or more conventional processors and unique stored program instructions that control the one or more processors to implement, in conjunction with certain non-processor circuits, some, most, or all of the functions of a receiver having at least two antennae is provided to solve the problem of when, where, or how the receiver is to combine the received signals. The non-processor circuits may include, but are not limited to, a radio receiver, a radio transmitter, signal drivers, clock circuits, power source circuits, and user input devices. As such, these functions may be interpreted as steps of a method to perform providing a receiver having at least two antennae is provided to solve the problem of when, where, or how the receiver is to combine the received signals. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

8-VSB (8-level vestigial sideband) is a standard radio frequency (RF) modulation format chosen by the Advanced Television Systems Committee (ATSC) for the transmission of digital television (DTV) in such countries as the United States and other adopting countries. 8-VSB is used in the transmission of video data. There is also a 16-VSB mode that has 16 amplitude levels. 8-VSB is considered effective in multi-casting in that simultaneous transmission of more than one DTV program is achieved. Further, 8-VSB is also considered effective in datacasting in that the transmission of data along with a television program is achieved.

In addition, VSB transmission system possesses large bandwidth, which is needed to transmit HDTV (high definition television) programming. VSB has single side band thereby having improved or better adaptability in protecting against adjacent channel interference. Further, single side band has better performance at higher bit rates. VSB uses the entire bandwidth as a single frequency having all component parts multiplexed together. The benefits therefrom include lower broadcast power and the possibility of extended station coverage. VSB further minimizes interference with analog NTSC signals, which are required to be transmitted simultaneously with the digital signals. NTSC uses an analog VSB modulation. Still further, VSB being a Single Frequency Network (SFN) can improve the signal strength throughout an entire service area, thereby allowing even remote and heavily walled locations to receive the desired signals.

In a VSB system a transmitter transmits signals through some media such as a radio frequency channel. Due to the geographic structure between the transmitter and the receiver, signals arriving at the receiver usually undergo a inter-symbol interference due to multipath effects. In order to recover the transmitted VSB signals, It is noticed that forming an antenna diversity chain after RS decoder is advantageous. Under the ATSC standard, antenna diversity chain can be implemented after RS decoder. By using RS decoder un-correctable error flag and associated eraser-based RS decoder, inter-symbol interference can be reduced. This chain structure can pick up the most optimum path among at least 2-8 received signal paths through diversified antenna. For detailed embodiments, see infra.

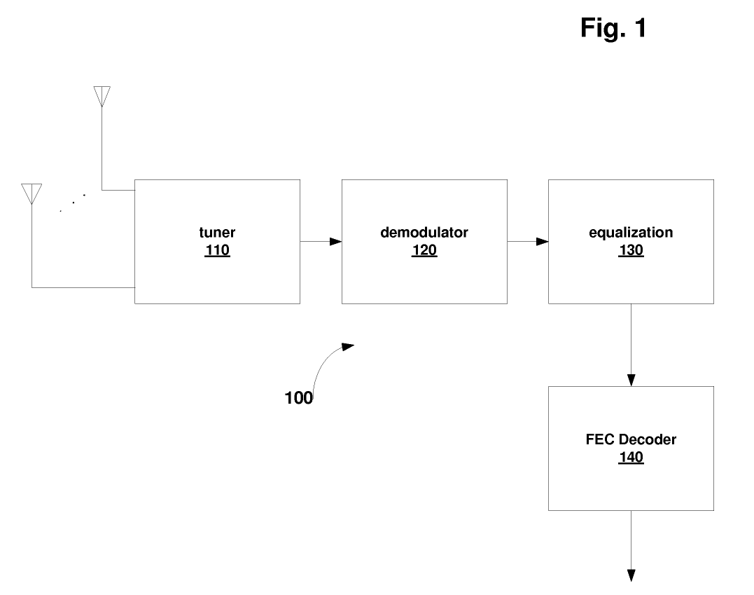

Referring to FIG. 1, a block diagram of a multi antanea digital television receiver 100, which can process a VSB signal, is shown. The digital television receiver 100 includes a tuner 110, a demodulator 120, an equalizer 130, and a forward error control (FEC) decoder 140. TCM coding may use an error correction technique, which may improve system robustness against thermal noise. TCM decoding may have more robust performance ability and/or a simpler decoding algorithm. The output signal OUT of the TCM decoder 140 may be processed by a signal processor and output as multimedia signals (e.g., display signals and/or audio signals).

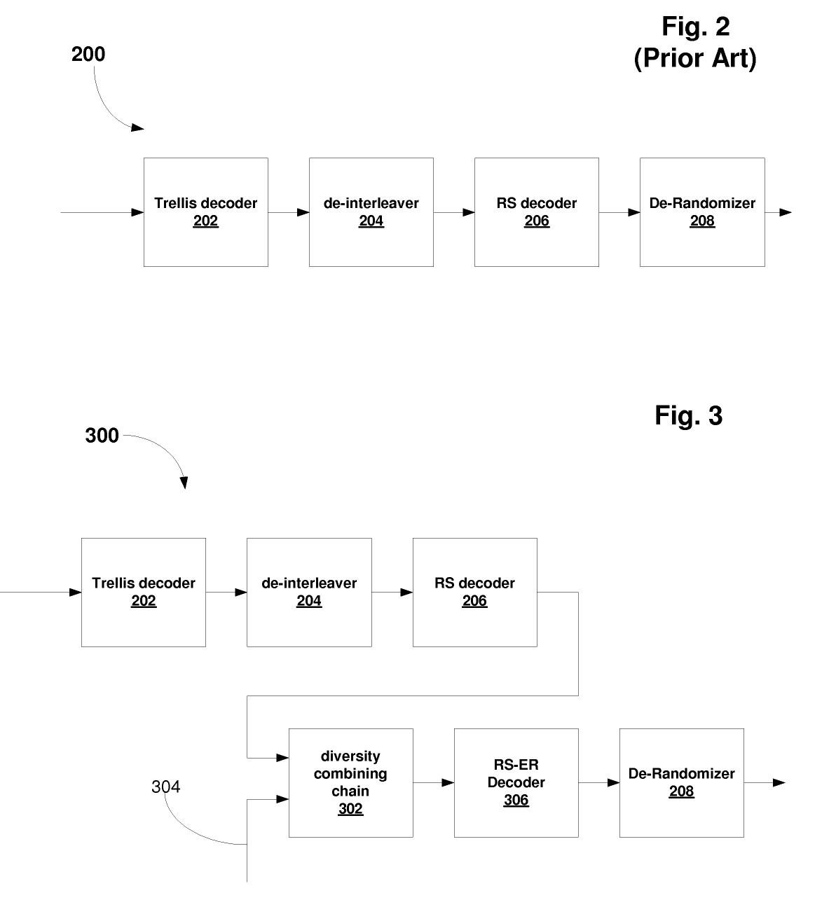

Referring to FIG. 2, a prior art VSB receiver 200 is shown. A transport stream (TS) including data coming from a demodulator (not shown) is input into trellis decoder 202. The decoded data are subjected to a de-interleaver 204. The interleaved data, in turn, is subjected a Reed-Solomon decoder 206 such as a Reed-Solomon decoder. The decoded data is further subjected to a de-randomizer 208. The de-randomized data is fed downstream for further process.

Referring to FIG. 3, a first aspect of a VSB receiver 300 in accordance with some embodiments of the invention is shown. The receiver 300 uses a novel FEC decoding scheme. A transport stream (TS) derived from a first antenna (not shown) including data coming from a demodulator (not shown) is input into trellis decoder 202. The decoded data are subjected to a de-interleaver 204. The interleaved data, in turn, is subjected a Reed-Solomon decoder 206 such as a Reed-Solomon decoder. The decoded data feed into a diversity combining chain block 302. Block 302 also receives a second feed 304 of information derived from a second antenna (also not shown). In practice, feed 304 may come from a second chip (also not shown) associated with a second antenna. Whereas, the instant decoded data come from a first chip associated with the first antenna. The combined data is further input into a 306. The decoded data is further subjected to a de-randomizer 208. The de-randomized data is fed downstream for further process.

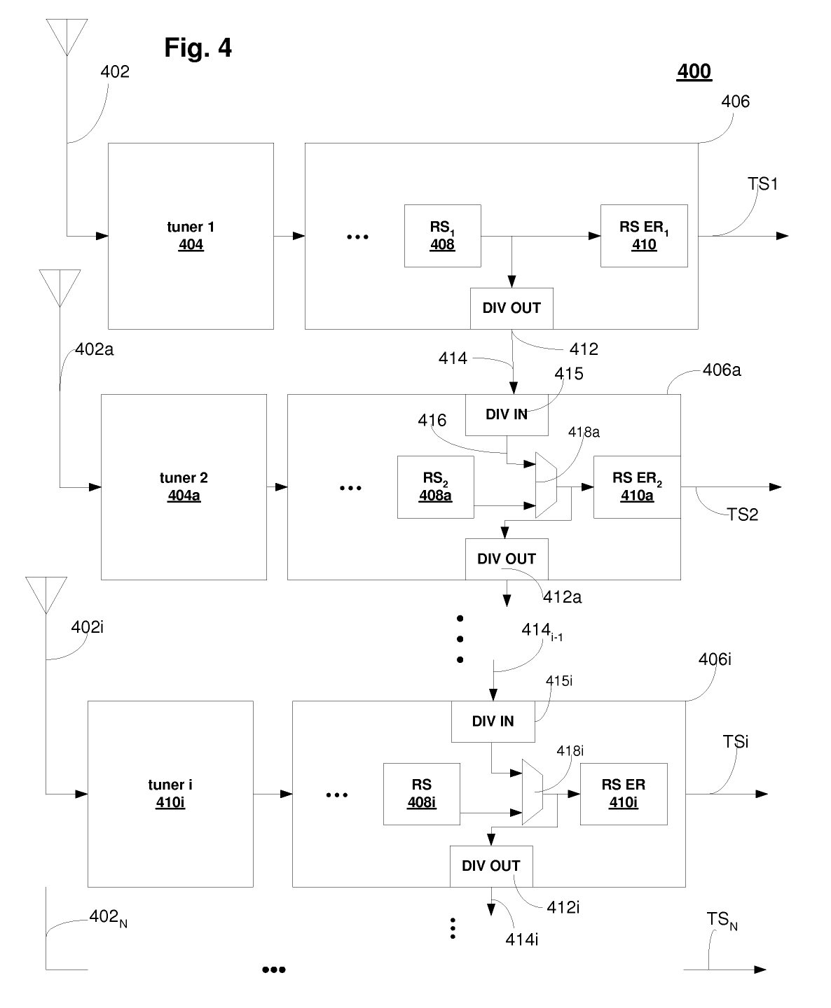

Referring to FIG. 4, a second aspect of the VSB receiver 400 in accordance with some embodiments of the invention is shown. A first antenna 402 associated with a first data path receives wireless information including wireless data and feeds same into a first tuner 404. The tuned information in turn is fed into block 406 that comprises a first Reed-Solomon decoder 408 along first data path. Block 406a may form a single IC chip. The decoded data of the first path or first transport stream (TS₁), at this juncture, are both fed forward along the first path and fed branchwise toward a second path that is shown in detail infra. Returning to the first path, the decoded data in further fed into a Reed-Solomon erasure block 410. Within block 410, the decoded data is subjected to processes and/or apparatus described in U.S. patent application Ser. No. 12/041,514 with attorney docket number LSFFT-097. The TS₁ data is fed downstream for further process.

Turning now to the second transport stream (TS₂), a second antenna 402 associated with a second data path receives wireless information including wireless data and feeds same into a second tuner 404a. The tuned information in turn is fed into block 406a that comprises a second Reed-Solomon decoder 408a along second data path. Block 406a may form a single IC chip. The decoded data of the second path or second transport stream (TS₂), are fed forward along the second path into a combiner 418. Additionally, also at this juncture, a diversification input port 415 receives the diversification output 414 of block Reed-Solomon decoder 206 and using same as an input 416 into combiner 418. The combined information is fed branchwise toward a third path (not shown) via a diversificatin output 412b port. Returning to the second path, the combined information is further fed into a Reed-Solomon erasure block 410a. Within block 410a, the decoded data is subjected to processes and/or apparatus described in U.S. patent application Ser. No. 12/041,514 with attorney docket number LSFFT-097. The TS₂ data is fed downstream for further process.

Turning now to the i^{th} transport stream (TSᵢ), a i^{th} antenna 402i associated with an i^{th} data path receives wireless information including wireless data and feeds same into an i^{th} tuner 404i. The tuned information in turn are fed into block 406i that comprises an i^{th} Reed-Solomon decoder 408i along i^{th} data path. Block 406i may form a single IC chip. The decoded data of the i^{th} path or i^{th} transport stream (TSᵢ) are fed forward along the i^{th} into a combiner 418i. Additionally, also at this juncture, a diversification input port 415a receives the diversification output 414ᵢ₋₁ of block Reed-Solomon decoder 206ᵢ₋₁ (not shown) and using same as an input 416i into combiner 418i. The combined information is fed branchwise toward an i+1^{th} path (not shown) via a diversification output 412b port. Returning to the i^{th} path, the decoded data in further fed into a Reed-Solomon erasure block 410i. Within block 410i, the decoded data is subjected to processes and/or apparatus described in U.S. patent application Ser. No. 12/041,514 with attorney docket number LSFFT-097. The TSᵢ data is fed downstream for further process.

There may be up to N paths having similar structures as described supra. As can be seen, TS₁, TS₂, . . . , TSᵢ, . . . , TS_{N} paths have similar structure.

As a practical example, a 2-anttenna system is only the first path and the second path is used. The diversity chain consists of two antenna receivers spanning path 1 and path 2 of FIG. 4. The input signals from antenna 402 and antenna 402a are through different mult-path channels. By subjecting the transport streams (TS1 and TS2) demodulation and FEC decoder, different error locations are formed at the TS streams. For RS decoder used in ATSC standard, if more than 10 errors are present in a RS data packet, the errors are un-correctable. RS decoder can send out an error flag associated with the current packet. So we can use this feature, error flag, to realize the antenna diversity. We align two received TS streams from the outputs of 2 RS decoder corresponding to receiver A or path 1 and B or path2, and pick up the path which has no un-correctable error (error flag is not activated), and select the path as the final output to MPEG decoder through the de-randomizer. This diversified system gives better performance than the one-antenna system.

Furthermore, another eraser-based RS decoder may be added behind the diversity-combine-chain. U.S. patent application Ser. No. 12/041,514 with attorney docket number LSFFT-097 discloses such a eraser-based RS decoder. When the two aligned RS packet both have more than 10 errors (the two RS error flag indications are activated), we can compare each byte in the two packets, when the content of the bytes are not same, we set the eraser indication for the current byte. According to the eraser-based RS decoder, it can correct up to 2t+e≦dₘᵢₙ−1 erators (t is the number of errors, e is the number of erasers). For the RS code used in ATSC standard, dₘᵢₙ=20. Further more, we can extend the chain by using more antennas. As shown in FIG. 4.

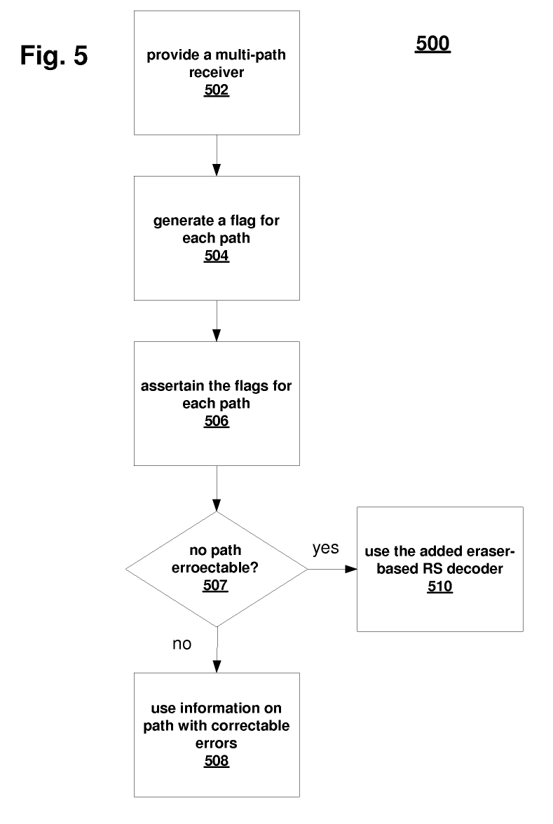

Referring to FIG. 5, a flowchart 500 for path selection is shown. a multi-antenna receiver having a plurality of paths having each path associated with an antenna is provided (Step 502). Each path generates a flag signal indicating whether is error is correctable or not (Step 504). For example, if the error is uncorrectable, FLAG=1; otherwise FLAG=0. The error flag value is ascertained for each path (Step 506). A determination is made as to whether all the paths are correctable or not (Step 507). If there are some paths that is correctable, select or use information on the one or more paths with correctable errors (Step 508). In other words, select the one having FLAG=0, thereby improving upon the reception of the receiver. If all the paths have uncorrectable errors, use the added eraser-based RS decoder behind the diversity-combine-chain (Step 510).

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Terms and phrases used in this document, and variations thereof, unless otherwise expressly stated, should be construed as open ended as opposed to limiting. As examples of the foregoing: the term “including” should be read as mean “including, without limitation” or the like; the term “example” is used to provide exemplary instances of the item in discussion, not an exhaustive or limiting list thereof; and adjectives such as “conventional,” “traditional,” “normal,” “standard,” and terms of similar meaning should not be construed as limiting the item described to a given time period or to an item available as of a given time, but instead should be read to encompass conventional, traditional, normal, or standard technologies that may be available now or at any time in the future. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise.

What is claimed is:

1. A receiver comprising:
a plurality of paths for receiving wireless signals, each path having a designated antenna; and
an antenna diversity chain adapted for information communication between the plurality of paths for a selecting and using at least one path among the plurality of paths.

2. The receiver of claim 1 further comprising an eraser-based RS decoder downstream to the antenna diversity chain associated with each path.

3. The receiver of claim 1, wherein the antenna diversity chain is formed after a RS decoder in each path.

4. The receiver of claim 1, wherein the RS decoder in a path generates an un-correctable error flag if error associated with the path is uncorrectable.

5. The receiver of claim 4, wherein at least one path without un-correctable error flag is selected.

6. The receiver of claim 4, wherein an eraser-based RS decoder downstream to the antenna diversity chain associated with each path is used when no path has correctable error.

7. The receiver of claim 1, wherein the receiver is a variable sideband receiver.

8. A method used in a receiver comprising the steps of:
providing a plurality of paths for receiving wireless signals, each path having a designated antenna; and
providing an antenna diversity chain adapted for information communication between the plurality of paths for a selecting and using at least one path among the plurality of paths.

9. The method of claim 8 further comprising the step of providing an eraser-based RS decoder downstream to the antenna diversity chain associated with each path.

10. The method of claim 8, wherein the antenna diversity chain is formed after a RS decoder in each path.

11. The method of claim 8, wherein the RS decoder in a path generates an un-correctable error flag if error associated with the path is uncorrectable.

12. The method of claim 11, wherein at least one path without un-correctable error flag is selected.

13. The method of claim 11, wherein an eraser-based RS decoder downstream to the antenna diversity chain associated with each path is used when no path has correctable error.

14. The method of claim 8, wherein the receiver is a variable sideband receiver.
